(19) United States
(12) Patent Application Publication
(10) Pub. No.: US 2026/0169431 A1
(43) Pub. Date: Jun. 18, 2026

(54) PALLET WITH CURVED PALLET STONES FOR A SWISS PALLET ESCAPEMENT MECHANISM

(71) Applicant: ETA SA Manufacture Horlogère Suisse, Grenchen (CH)

(72) Inventors: Pascal WINKLER, St-Blaise (CH); Dominique LECHOT, Les Reussilles (CH); Jean-Jacques BORN, Morges (CH); Gianni DI DOMENICO, Neuchâtel (CH); Mohammad Hussein KAHROBAIYAN, Boudevilliers (CH)

(73) Assignee: ETA SA Manufacture Horlogère Suisse, Grenchen (CH)

(21) Appl. No.: 19/415,037

(22) Filed: Dec. 10, 2025

(30) Foreign Application Priority Data
Dec. 18, 2024 (EP) 24221243.9
Dec. 20, 2024 (CH) 001449/2024
Dec. 20, 2024 (EP) 24222298.2
Apr. 16, 2025 (EP) 25171020.8

(51) Int. Cl. G04B 15/14

(52) U.S. Cl. CPC G04B 15/14

(57) ABSTRACT

A pallet (21) for a horology escapement mechanism (50) with a Swiss pallet, the pallet (21) including a fork (22) designed to engage with an ellipse (23) on a balance (35), an entry arm (11) and an exit arm (12) designed to engage with an escapement mobile (30), the entry arm (11) and the exit arm (12) each comprising a pallet stone (25, 26), the pallet stone (25) on the entry arm (11) and/or the pallet stone (26) on the exit arm (12) including a lateral wall (27, 28) located on the side opposite to the lock plane, the lateral wall (27, 28) having a portion (29, 33) curving towards the inside of the pallet stone (25, 26).

### CROSS REFERENCE TO RELATED APPLICATIONS

This application claims priority to European Patent Application No. 24221243.9 filed Dec. 18, 2024, European Patent Application No. 24222298.2 filed Dec. 20, 2024, Swiss Patent Application No. CH 001449/2024 filed Dec. 20, 2024, and European Patent Application No. 25171020.8 filed Apr. 16, 2025, the disclosures of which are incorporated by reference herein in their respective entireties.

### TECHNICAL FIELD OF THE INVENTION

The present invention relates to a pallet with curved pallet stones for a horological escapement mechanism, as well as to an escapement mechanism and a horology movement comprising such a pallet.

### TECHNOLOGICAL BACKGROUND

In most mechanical watches, the energy required to rotate the hands (for example, the minute and hour hands) is accumulated in a barrel, then dispensed by a sprung balance system, which comprises a flywheel called a balance, combined with a spring in the form of a strip wound into a spiral, called a balance spring

At an inner end, the balance spring is attached to an arbor that rotates with the balance; at an outer end, the balance spring is attached to a balance spring stud fitted on a stud holder, which is itself attached to a fixed bar (or cock).

The rotation of the balance is maintained-and its oscillations counted-by an escapement mechanism comprising a pallet driven by a low amplitude oscillating movement, provided with two or three pallet stones that engage the teeth of an escapement mobile. When thus engaged, the escapement mobile is forced into a step-by-step rotational movement at a frequency determined by the oscillation frequency of the pallet, which is itself set to the oscillation frequency of the sprung balance.

With a conventional escapement mechanism, the oscillation frequency is around 4 Hz, or approximately 28,800 vibrations per hour (A/h). Good horologists aim to ensure that the sprung balance. oscillates isochronously and steadily (meaning that the rate remains constant).

The pallet in the escapement mechanism is designed to provide a mechanical link between the balance and the escapement mobile. The positioning of the pallet is therefore important to ensure that it engages correctly with the other two components.

Generally, the pallet is formed by a monobloc body comprising a fork engaging with an ellipse on the balance and at least two arms, each often fitted with a pallet stone, engaging with the escapement mobile. The body of the pallet is fitted on an arbor comprising a pivot at each end. During assembly, the pivots are inserted into bearings arranged in the bars or the plate.

Today, the balance spring can be replaced with a flexible guide as the spring part to form a virtual pivot. Flexible guides with virtual pivots make it possible to significantly improve horology resonators. The simplest are cross-blade pivots, consisting of two guides with straight crossed blades. These two blades can be either three-dimensional in two different planes or two-dimensional in the same plane, in which case they are soldered together at their crossing point. But there are also RCC (Remote Center Compliance) guides with uncrossed blades, which have straight blades that do not cross. Such a resonator is described in documents EP14199039, and EP16155039.

However, with such a flexible guide, the balance has a much smaller amplitude, the angle of rotation being around twenty degrees, whereas with a sprung balance the angle of rotation is 330°, and the balance oscillates with a much higher frequency than that of a balance fitted on a balance spring.

New escapement mechanism configurations have therefore been invented to function with a regulating organ with a flexible guide.

In most mechanical movements, the escapement mobile arbor, the pallet arbor and the sprung balance arbor are in the same plane. Seen from above, the position of these three axes forms a straight line. This is known as inline centring. However, this arrangement is quite cumbersome.

In certain horology movement configurations, the positions of the three axes form a bend. In other words, the escapement mobile, the pallet and the balance are not aligned, but are triangularly arranged, each at the top of the same triangle. Such an arrangement makes it possible to reduce the size of the horology movement.

Generally, the pallet fork and the pallet stones on the pallet are located at the same level in the movement. Moreover, as the fork engages the ellipse on the balance and the pallet stones engage the teeth on the escapement mobile, the fork and the pallet stones must be kept away from each other so that there is no collision between the ellipse and the teeth on the escapement mobile. The above explains why inline “centring” is generally used.

So on one hand, the relative position, in particular the centre distance, between the pallet and the escapement mobile must be well defined. On the other hand, the relative position, in particular the centre distance, between the pallet and the balance must also be well defined.

As the pallet stones and fork generally belong to the same part (the pallet) and engage substantially on the same level, it is difficult to meet both requirements simultaneously.

In Swiss pallet mechanisms, the escapement mobile comprises teeth fitted with an impulse beak extending at least partially tangentially to the escapement mobile towards the rear of the tooth relative to the direction of rotation of the escapement mobile. Such an impulse beak provides a larger impulse surface for contacting the pallet stone on the pallet.

However, this configuration of teeth increases the risk of shock with the pallet stones on the pallet because the teeth are enlarged. In fact, the pallet stones must not touch the side of a tooth on the pallet when it moves between two teeth in order to lock the wheel.

The arrangement of the pallet stones relative to the pallet teeth is therefore important. Pallet stones capable of engaging with such toothing need to be designed and available.

The pallets used in known Swiss pallet mechanisms comprise synthetic or ceramic pallet stones with straight walls.

To avoid shocks, the pallet stones are arranged on the pallet so as to be separate from the teeth, with a minimum safety distance when moving between the teeth.

However, the greater the safety distance, the greater the impact on the performance of the mechanism, which is significantly reduced.

Moreover, new technologies make it possible to manufacture components in innovative materials with particular advantages. For example, silicon components are made.

### SUMMARY OF THE INVENTION

The present invention aims to provide a pallet for a Swiss pallet escapement mechanism, which avoids the aforementioned drawbacks and makes it possible, in particular, to improve the performance of the escapement mechanism, while maintaining a sufficient safety distance between the pallet stones on the pallet and the teeth on the escapement mobile while the escapement mechanism is functioning.

To this end, the invention relates to a pallet for a horology escapement mechanism with a Swiss pallet, the pallet comprising a fork designed to engage with an ellipse on a balance, an entry arm and an exit arm designed to engage with an escapement mobile, the entry arm and the exit arm each comprising a pallet stone, the pallet stones being designed to engage with teeth on the escapement mobile.

The invention is remarkable in that the pallet stone on the entry arm and/or the pallet stone on the exit arm comprises a lateral wall located on the side opposite to the lock plane, the lateral wall having a portion curving towards the inside of the pallet stone.

This curved portion thus increases the safety distance between the pallet stone and the teeth on the escapement mobile, particularly with the impulse beak. But it ensures sufficient performance of the escapement mechanism.

In fact, the curved portion makes it possible to reduce the thickness of the pallet stone in a precise zone, the one closest to the teeth on the escapement mobile.

According to a particular embodiment of the invention, pallet stone on the entry arm comprises an outer lateral wall with the curved portion.

According to a particular embodiment of the invention, pallet stone on the exit arm comprises an inner lateral wall with the curved portion.

According to a particular embodiment of the invention, the lateral wall of the pallet stone is designed to avoid contact with teeth of the escapement mobile.

According to a particular embodiment of the invention, the curved portion comprises two facets forming an angle comprised between 90°and 160°, preferably between 105° and 150°, or even between 120° and 140°.

According to a particular embodiment of the invention, the pallet stone comprises an impulse face forming an angle with the outer face, the angle preferably being comprised between 20° and 70°, or even between 30° and 60°.

According to a particular embodiment of the invention, the pallet stones are formed at least partially from a material comprising silicon, preferably completely.

According to a particular embodiment of the invention, the pallet is formed from a material comprising silicon, preferably completely.

According to a particular embodiment of the invention, the pallet comprises an arbor on which the fork, the entry arm and the exit arm are fitted.

The invention also relates to an escapement mechanism comprising an escapement mobile comprising toothing fitted with teeth, and such a pallet.

According to a particular embodiment of the invention, the teeth are fitted with an impulse beak.

The invention also relates to a horology movement comprising a plate, a balance, a balance cock, a flexible guide, the balance being suspended by the flexible guide and such an escapement mechanism.

According to a particular embodiment of the invention, the balance, the escapement mobile and the pallet are arranged so as to form a bend with an angle of less than 90°, preferably less than 70° or even less than 60°.

### BRIEF DESCRIPTION OF THE FIGURES

Other features and advantages of the invention will be more clearly apparent from reading the following description of a particular embodiment of the invention, provided merely as an illustrative and non-limiting example, and from the appended figures, among which:

FIG. 1 is a schematic top view of a horology module comprising a regulating organ and an escapement mechanism,

FIG. 2 is a schematic side view of the horology module in FIG. 1,

FIG. 3 is a schematic cross-sectional view of a horology movement comprising the horology module in FIGS. 1 and 2,

FIG. 4 is a schematic top view of an escapement mechanism comprising a horology mobile, according to the third embodiment of the invention;

FIG. 5 is an enlarged schematic top view of part of the escapement mechanism in FIG. 4, and

FIG. 6 is a schematic perspective view of the pallet according to the invention.

### DETAILED DESCRIPTION OF THE INVENTION

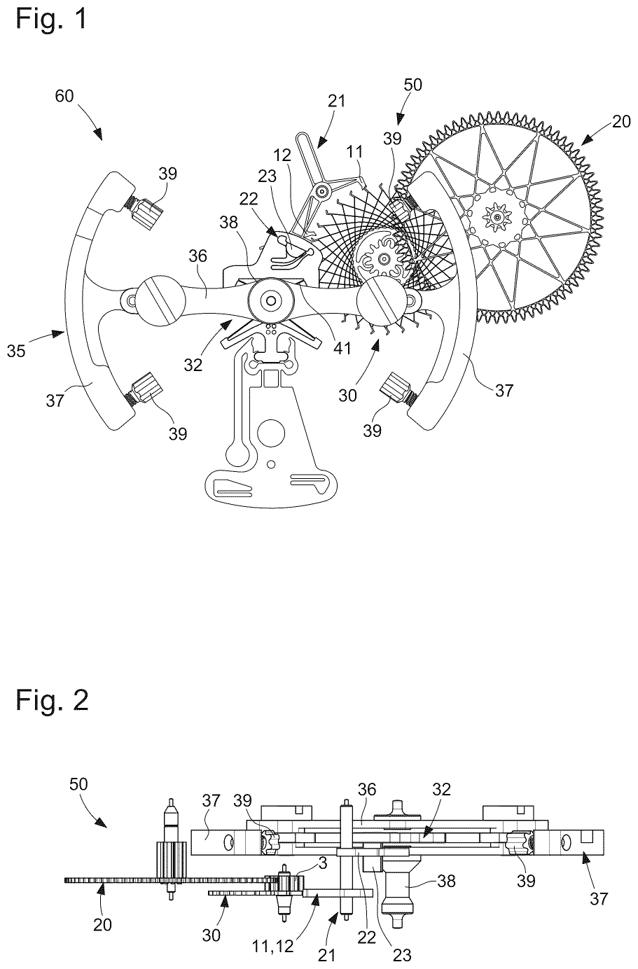

In FIGS. 1 and 2, the horology module 10 comprises a Swiss pallet escapement mechanism 50 associated with a regulating organ 60.

The regulating organ 60 comprises a balance 35, and a rotational flexible guide 32 for the balance 35, while the escapement mechanism 50 comprises an escapement mobile 30 and a pallet 21.

The balance 35 is shaped like a bone fitted with a longitudinal portion 36 and with a lateral portion 37 in the form of a circular arc at each end of the longitudinal portion 36. The balance 35 further comprises stops concentric with the virtual axis of rotation fitted in the middle of the longitudinal portion 36 and screws 39 for setting the inertia of the balance arranged in the lateral portions 37.

The balance 35 is fitted on the flexible guide 32 to enable it to perform a rotational oscillatory movement around a virtual axis of rotation. The flexible guide 32 is directly connected to the balance 35.

The flexible guide 32 is fitted with at least two flexible blades 37, in this example two pairs of crossed flexible blades 37, arranged in series and forming a double pivot to increase the angle of rotation of the balance 35.

The escapement mobile 30 comprises a hub 3, two series of blades 5, 16 and peripheral toothing 24. The peripheral toothing 24 comprises teeth 28 arranged at the junction of the free ends of a blade 5 in the first series and of a blade 16 in the second series. Moreover, the blades 16 in the second series are curved.

The teeth 28 are bent to form an impulse beak extending at least partially tangentially to the escapement mobile 30 towards the rear of the tooth 18 relative to the direction of rotation of the escapement mobile 30.

The escapement mechanism 50 further comprises a second horology mobile 20 meshing with the first escapement mobile 30. For example, the second horology mobile 20 is a seconds mobile. The teeth 14 on the second horology mobile 20 mesh with a pinion 3 on the first escapement mobile 30.

The balance 35 comprises an ellipse 23 extending under the balance 35 to engage the fork 22 on the pallet 21. The ellipse 23 is attached to the balance 35.

The centre of the balance 35, the escapement mobile 30 and the pallet 21 are arranged on a line forming a bend. This is in contrast to conventional escapement mechanisms, in which this line is substantially straight and the pallet is arranged on this line between the balance and the escapement mobile.

The balance 35, the escapement mobile 30 and the pallet 21 are therefore each arranged at the top of a triangle.

The bend has an angle of less than 90°, preferably less than 70° or even less than 60°. The balance 35, the escapement mobile 30 and the pallet 21 are therefore compactly arranged.

The pallet 21 is fitted with two arms 11, 12, an entry arm 11 and an exit arm 12, the ends of which each comprise a pallet stone 25, 26 engaging with the teeth 18 on the escapement mobile 30.

The pallet stones 25, 26 on the arms 11, 12 on the pallet 21 engage with the escapement mobile 30 and alternately interact with the teeth 18 on the escapement mobile 30 to regulate the rate.

The pallet 21 also comprises a longitudinal part 14 that extends laterally and is fitted with a fork 22 at its end to engage with an ellipse 23 on a balance 35.

Moreover, the pallet 21 comprises an arbor 5 substantially perpendicular to the longitudinal part 14 and to the fork 22, and which enables it to be fitted so as to rotate in the movement.

The pallet 21 comprises a radially extending elongate body 31, said body 31 being arranged to engage with stops, not shown in the figures. The purpose of the stops is to keep the pallet 21 from rotating too much.

The elongate body 31 is arranged substantially at the level of the entry 11 and exit 12 arms on the pallet 21.

The fork 22 and the entry arm 11 and exit arm 12 are arranged in two parts on the arbor 5. The fork 22 is arranged on a first level of the arbor 5 while the entry arm 11 and exit arm 12 are arranged on a second level of the arbor 5.

In this way, the two levels are separated along the axis of the arbor 5 by a predetermined distance D0. Preferably, the distance is comprised between one quarter and three quarters of the length of the arbor.

For example, the first level is arranged substantially at a lower end of the arbor while the second level is arranged substantially in the middle of the arbor.

Preferably, the arbor 5 has a length corresponding substantially to the height of the horology movement, starting from the plate 2.

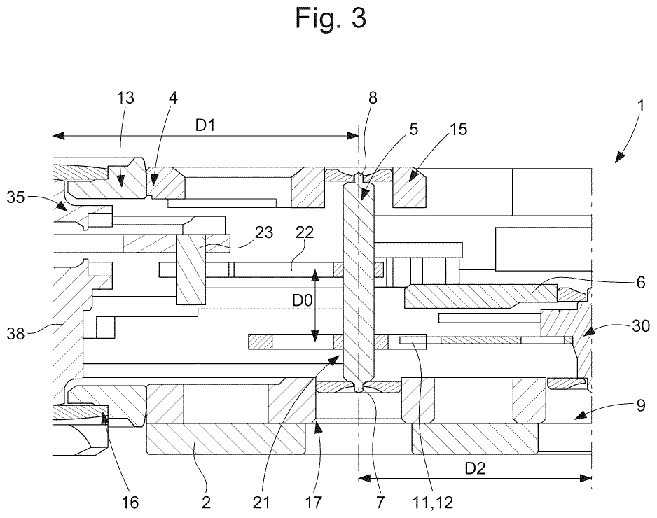

In FIG. 3, the horology module in FIGS. 1 and 2 is arranged in a horology movement 1, in particular for a watch.

In addition to the horology module 10, the horology movement 1 comprises a plate 2 and bars for supporting the components in the horology module 10.

In particular, the horology movement 1 comprises a balance cock 4 arranged above the balance 4. The balance 4 therefore oscillates between the plate 2 and the balance cock 4. For example, the balance cock 4 comprises an upper stop to secure the balance 35 vertically.

The horology movement 1 also comprises an escapement bar 6 to keep the axis on the escapement mobile 30 pivoting.

The escapement mobile 30 is fitted so as to pivot between the plate 2 and the escapement bar 6. The balance 35 is thus fitted so as to pivot between the balance cock 4 and the plate 2.

The arbor 5 comprises a first pivot 7 arranged at a first end of the arbor 5 and a second pivot 8 arranged at a second end of the arbor 5.

The first pivot 7 is fitted so as to pivot on the plate 2, and the first [sic: second?] pivot 8 is fitted so as to pivot in the balance cock 4. The pallet 21 is thus fitted so as to pivot between the balance cock 4 and the plate 2. And the arbor 5 extends beyond the balance 35.

To this end, the balance cock 6 comprises a first bearing 13 for the balance 37, which acts as a stop in the event of a shock and is concentric with the virtual axis of rotation defined by the flexible guide 32, and a second bearing 15 for the pallet 21. The distance D1 between the centre of the first bearing 13 and the centre of the second bearing 15 is predetermined to enable optimum engagement between the fork 22 on the pallet 21 and the ellipse 23 on the balance 6.

The plate 2 comprises a third bearing 16 for the balance 35, a fourth bearing 17 for the arbor 5 on the pallet 21, and a fifth bearing 9 for the escapement mobile 30. The distance D2 between the centre of the fourth bearing 17 and the centre of the fifth bearing 19 is predetermined to enable optimum engagement between the arms 11, 12 on the pallet 21 and the escapement mobile 30.

The escapement bar 6 comprises a sixth bearing 24 for a pivot on the escapement mobile 30.

This arrangement of the pallet 21 better ensures the engagement between the arms 11, 12 on the pallet 21 and the escapement mobile 30 on one hand, and the engagement between the fork 22 and the ellipse 23 on the other hand. Indeed, the arbor 5 is unlikely to be too inclined relative to the plate 2.

Since the pallet 21 and the balance 35 are arranged between the plate 2 and the balance cock 4, the distance D1 of the centre distance defined between the first pivot 8 on the balance 35 and that of the pallet 21 on the balance cock 4 is constant and is unlikely to vary during assembly.

Similarly, the distance D2 of the centre distance defined between the first pivot 7 on the pallet and the pivot on the escapement mobile 30 on the plate 2 is constant and does not vary during assembly.

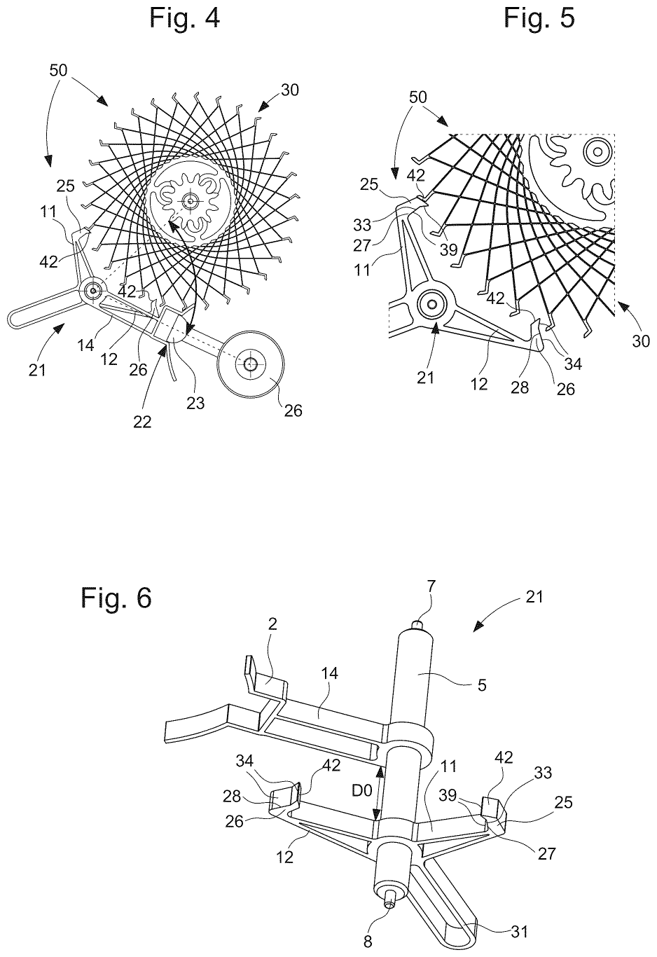

According to the invention, in FIGS. 4 to 6, the pallet stone 25 on the entry arm 11 and the pallet stone 26 on the exit arm 12 on the pallet 21 comprise a lateral wall 27, 28 with a curved portion 29, 33.

In this embodiment, the two pallet stones 25, 26 each comprise a lateral wall 27, 28 with a curved portion 29, 33.

The curved portions 29, 33 are on the side of the pallet stone 25, 26 facing the free end of the teeth 18. Thus, the side wall 27, 28 of each pallet stone 25, 26 is located on the side opposite to the lock plane.

The pallet stone 25 on the entry arm 11 comprises an outer wall 27 curved towards the inside of the pallet stone 25, and the pallet stone 26 on the exit arm 12 comprises an inner wall 27 curved towards the inside of the pallet stone 26.

In this embodiment, the curved portion 29, 33 comprises two facets 34, 39 forming an angle comprised between 90° and 160°, preferably between 105° and 150°, or even between 120° and 140°.

Each pallet stone 25, 26 comprises an impulse face 42 forming an angle with the lateral wall 27, 28, the angle preferably being comprised between 20° and 70°, or even between 30° and 60°.

The pallet stones 25, 26 are formed at least partially from a material comprising silicon, preferably completely. In fact, this material enables curved portions 26, 29 to be produced.

Preferably, the pallet 21 is completely formed from a material comprising silicon, preferably completely. The pallet 21 is therefore preferably made in one piece with the pallet stones 25 and 26, and is made of the same material.

Naturally, the invention is not limited to the embodiments described with reference to the figures, and variants could be envisaged without departing from the scope of the invention.

1. A pallet (21) for a horology escapement mechanism (50), the pallet (21) comprising a fork (22) designed to engage with an ellipse (23) on a balance (35), an entry arm (11) and an exit arm (12) designed to engage with an escapement mobile (30), the entry arm (11) and the exit arm (12) each comprising a pallet stone (25, 26), wherein the pallet stone (25) on the entry arm (11) and/or the pallet stone (26) on the exit arm (12) comprises a lateral wall (27, 28) located on the side opposite to the lock plane, the lateral wall (27, 28) having a portion (29, 33) curving towards the inside of the pallet stone (25, 26).

2. The pallet according to claim 1, wherein the pallet stone (25) on the entry arm (11) comprises an outer lateral wall (27) with the curved portion (29).

3. The pallet according to claim 1, wherein the pallet stone (26) on the exit arm (12) comprises an inner lateral wall (28) with the curved portion (33).

4. The pallet according to claim 1, wherein the lateral wall (27, 28) of the pallet stone (25, 26) is designed to avoid contact with teeth (18) of the escapement mobile (30).

5. The pallet according to claim 1, wherein the curved portion (29, 33) comprises two facets (34, 39) forming an angle comprised between 90° and 160°, preferably between 105° and 150°, or even between 120° and 140°.

6. The pallet according to claim 1, wherein the pallet stone (25, 26) comprises an impulse face (42) forming an angle with the lateral wall (27, 28), the angle preferably being comprised between 20° and 70°.

7. The pallet according to claim 1, wherein the pallet stones (25, 26) are formed from a material comprising silicon.

8. The pallet according to claim 1, wherein the pallet is formed from a material comprising silicon.

9. The pallet according to claim 1, further comprising an arbor (5) on which the fork (22), the entry arm (11) and the exit arm (12) are fitted.

10. A Swiss pallet escapement mechanism comprising an escapement mobile (30) comprising a toothing fitted with teeth (18), and the pallet (21) according to claim 1.

11. The escapement mechanism according to claim 10, wherein the teeth (18) are fitted with an impulse beak (43).

12. A horology movement comprising a plate (2), a balance (35), a balance cock (4), a flexible guide (32), the balance (35) being suspended by the flexible guide (32), so that it can oscillate around a virtual axis between the plate (2) and the balance cock (4), wherein the movement comprises the escapement mechanism according to claim 10.

13. The horology movement according to claim 12, wherein the balance (4), the escapement mobile (30) and the pallet (21) are arranged so as to form a bend with an angle of less than 90°.
